(19) United States
(12) Patent Application Publication
(10) Pub. No.: US 2006/0027310 A1
(43) Pub. Date: Feb. 9, 2006

(54) Shaping drum having rotary under-heel gripping means

(75) Inventor: Jacques Auclair, Cournon-D'Auvergne (FR)

Correspondence Address: COHEN, PONTANI, LIEBERMAN & PAVANE, Suite 1210, 551 Fifth Avenue, New York, NY, 10176, US

(73) Assignee: Michelin Recherche et Technique S.A., Granges-Paccot (CH)

(21) Appl. No.: 11/191,335

(22) Filed: Jul. 28, 2005

(30) Foreign Application Priority Data
Aug. 2, 2004 (FR) 04/08557

(51) Int. Cl. B29D 30/24

(52) U.S. Cl. 156/133; 156/130.7; 156/415

(57) ABSTRACT

A shaping drum (T) for a tire carcass (C), comprising two side plates (4, 4′), mounted on a shaft (1) of axis XX′ and moving axially on said shaft, said side plates comprising circumferential receiving grooves (6, 6′) intended to hold the heels of the tire to be shaped while forming an airtight contact with said heels, and in which the shaping of the tire takes place by increasing the air pressure within the volume (V) defined by the side plates and by the inner surface of the tire (C), and by bringing together the side plates (4, 4′), wherein during the shaping, at least one of the side plates (4, 4′) is driven in rotation about said axis XX′ relative to the other side plate.

### FIELD OF THE INVENTION

The invention relates to a process for producing a tire comprising a carcass reinforcement, the reinforcement elements of which are radial in the sidewalls and are at an angle which is oblique relative to the circumferential direction in the regions located in the crown or in the zone located close to the heel.

More particularly, the invention proposes a suitable shaping drum which enables the process to be implemented.

### BACKGROUND OF THE INVENTION

Radial-carcass tires have been known for many years, and constant attempts are being made to improve their method of operation.

It is customary to divide the tire into three distinct zones comprising the crown zone, consisting of a crown reinforcement and a tread intended to come into contact with the ground, a heel zone intended to attach the tire to the rim and a sidewall zone intended to form the join between the two zones previously mentioned.

These tires comprise carcass reinforcement armatures or crown reinforcement armatures, composed of lengths of metal or textile cords coated in a rubber mix to constitute reinforcement plies. The lengths of cords form a precise angle with the circumferential direction; an angle close to 90° will be used for what is referred to as a “radial” reinforcement ply generally used to produce the carcass reinforcement, and a ply of a narrower angle, less than 90°, for the crown reinforcement plies. The crown reinforcement belt is generally formed of at least two plies, the angles of which are of opposite signs. What is called a zero-degree ply will be formed of reinforcement cords forming an angle close to 0° with the circumferential direction.

It has been known for a long time that using a radial carcass reinforcement, formed by reinforcement fibres oriented in a direction perpendicular to the circumferential direction, improves the performance of tires. However, analysing the method of operation of this type of tire shows that only that portion of carcass reinforcement located in the sidewalls needs to be truly radial in order to impart to the tire all the qualities attributed to this technology.

Thus it has been shown that the portion of carcass reinforcement located beneath the crown reinforcement could be unnecessary.

This is why numerous developments have been made to modify the angle of the carcass reinforcement ply in the crown zone in order to impart thereto properties which enable it to contribute to forming the crown reinforcement, in cooperation with another ply formed of reinforcement elements, the angle of orientation of which relative to the circumferential direction would be of the opposite sign to that of the carcass reinforcement elements in the zone located beneath the crown. In the zone of the crown reinforcement, the angles formed by the cords of the carcass reinforcement ply and by the crown reinforcement ply relative to the circumferential direction are generally of between 15° and 40°.

By way of example, this type of tire is described in patent FR 1 413 102. This tire comprises a carcass reinforcement formed of cords arranged radially or substantially radially in the zone of the heel and in the sidewall zone, which have an orientation which deviates substantially from the radial orientation over part of the zone over which the crown reinforcement extends.

Numerous embodiments have been proposed in support of these developments. These processes exploit the properties provided by the effects of the triangulation when two plies, superposed beforehand and adhering to one another, are of different angles and are opposed relative to a circumferential direction and are stretched in this same direction. This effect results in the reduction in the orientation of the angles of these plies relative to the circumferential direction.

A complete description of this so-called “triangulation” mechanism is given in publication FR 2 797 213.

To bring about this triangulation, it is advisable in a first phase, as set forth in patent FR 1 413 102, to arrange successively on a building drum of substantially cylindrical form one or more carcass reinforcement plies, the cords of which are oriented radially, then to arrange a crown reinforcement ply having cords oriented obliquely relative to the carcass cords, to make these different plies adhere together to form what it is conventionally agreed to call a carcass. Then in a second phase to shape the carcass on a shaping drum comprising a diaphragm, to form a tire blank of substantially toroidal form.

During the shaping phase, during which a tire blank of cylindrical form is transformed into a tire blank of toroidal form, the increase in the diameter of the central part intended to constitute the crown zone amounts to stretching the crown reinforcement ply and the carcass reinforcement ply in the longitudinal direction or alternatively in the circumferential direction, and imparting angles having a lower absolute value to the carcass reinforcement cords located in this crown zone and to the cords of the crown reinforcement ply.

One alternative to publication FR 1 413 102 is set forth in patent FR 1 508 652, in which the shaping or the rounding of the carcass of cylindrical form takes place directly in the vulcanisation press.

These different processes nevertheless exhibit the drawback of poorly controlling the formation of this triangulation and are very sensitive to variations in rigidity of the plies with the consequence that the angles of plies, are not readily reproducible from one tire to another, and that the developments of said tires may vary substantially.

### SUMMARY OF THE INVENTION

One object of the invention is to provide a shaping drum and also a process permitting good reproducibility of the triangulation for producing a tire the crown reinforcement belt of which is formed by the carcass reinforcement ply and the crown reinforcement ply.

Thus, it has been shown that controlling the axial rotation of the heels, throughout the shaping operation, made it possible to control extremely accurately the angle formed by the carcass reinforcement cords in the crown zone and also the angle of the cords of the crown reinforcement ply but also the radiality of the carcass reinforcement cords in the sidewall zone while retaining very good reproducibility of the diameter of the tire at the end of the shaping operation.

It will in fact be noted that the angular variation of the carcass reinforcement cords beneath the part of the crown is accompanied by circumferential displacement in opposite directions of the cords located in the sidewalls. And none of the processes mentioned above makes it possible, during the shaping phase, to control this rotation, which is partially prevented either by the shaping diaphragm (FR 1 413 102), or by the vulcanisation press (FR 1 508 652).

The tire carcass shaping drum according to the invention comprises two side plates, mounted on a shaft of axis XX′ and moving axially on said shaft. The side plates comprise circumferential receiving grooves intended to hold the heels of the tire to be shaped, while forming an airtight contact with said heels. During the shaping, the side plates are displaced axially relative to each other and at least one of the side plates is driven in rotation around said axis XX′ relative to the other side plate, so as to make it possible for the heels of the tire to rotate relative to one another freely or by a predetermined angle about the axis XX′.

The process for producing a tire comprises producing a tire carcass blank on a conventional cylindrical drum by laying successively a carcass reinforcement ply formed of reinforcement cords forming a given angle with the circumferential direction, the annular elements of the heel, turning up the ply edges to form the carcass upturn, and finally laying a crown reinforcement ply formed of reinforcement cords forming an angle with the circumferential direction, this angle being of the opposite sign to the angle formed by the carcass reinforcement ply. At this stage, it is advisable to provide a good join between the carcass reinforcement ply and the crown reinforcement ply by promoting the adhesion of one relative to the other.

The carcass thus produced is placed on a shaping drum, as described above, and in which the shaping operation proper is performed. This operation consists of varying the internal volume formed by the carcass and the side plates of the drum, and bringing said side plates axially towards one another, so as to make the carcass adopt a toroidal form; the diameter of the crown zone increases and the absolute values of the angles formed by the reinforcement cords of the crown reinforcement ply and the cords of the part of the carcass reinforcement ply located beneath the crown with the circumferential direction decrease under the effect of the triangulation.

It will be noted that the cords of the carcass ply located in the sidewall zone are not subjected to this triangulation and naturally have a tendency to become radialised, finishing by forming an angle substantially equal to 90° with the circumferential direction.

The effect of this radialization is to reduce the circumferential distance between the two anchoring points of one and the same carcass reinforcement cord on each of the bead wires. This movement together causes rotation of the heels about the axis XX′ in the opposite direction relative to each other.

The increase in pressure takes place directly in the enclosure defined by the internal wall of the tire blank and by the side plates on which the heels of said tire rest by airtight contact. By proceeding in this manner, all the elements capable of hindering the triangulation of the crown or the free rotation of heels about the axis of rotation of the shaping drum are eliminated.

The rotation of the side plates about their axis may be free, and result solely from the circumferential movement of the heels during the shaping, or controlled by mechanical means so as to improve the reproducibility of the process.

Once the shaping is finished, the tire blank receives the profiled elements intended for finishing it, which include a tread and possibly a second crown reinforcement ply.

Owing to the good reproducibility of the process, it is possible to lay a zero-degree crown reinforcement ply on the crown thus produced before the tread is laid.

### BRIEF DESCRIPTION OF THE DRAWINGS

The advantages linked to using a drum according to the invention will become apparent in the description hereafter, which sets out to give non-limiting examples of embodiment and use, referring to the figures, in which:

FIG. 1 represents a diagram of a drum according to the invention,

FIGS. 2, 3 and 4 represent diagrammatically an illustration of the stages of shaping of a tire blank,

FIGS. 5, 6 and 7 represent diagrammatically the stages of the triangulation of the crown zone and the bottom zone, and also the radialization of the sidewall zone,

FIGS. 8, 9 and 10 represent diagrammatically the stages of the triangulation of the bottom zone alone, and also the radialization of the sidewall zone and the crown zone,

FIG. 11 represents a view in section of a tire.

### DETAILED DESCRIPTION OF THE DRAWINGS

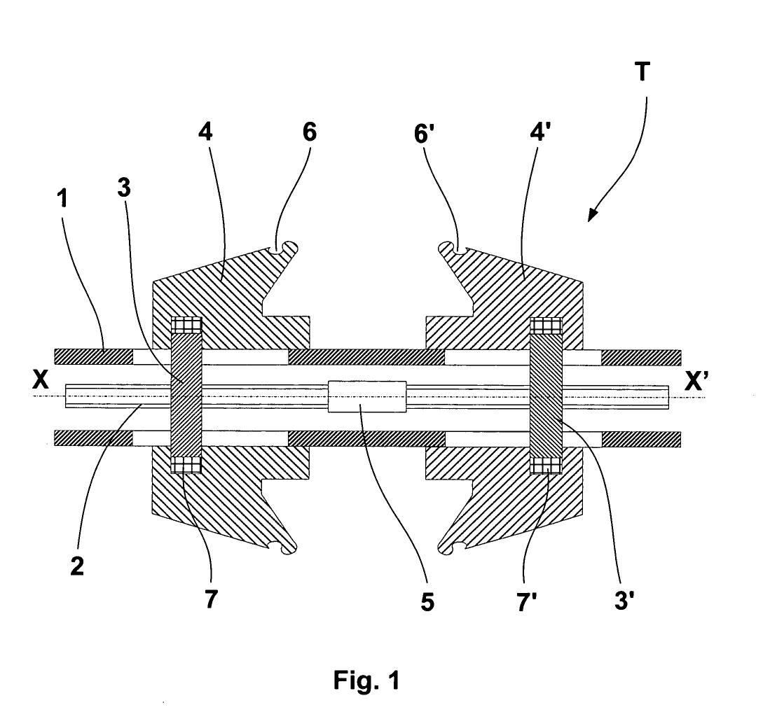

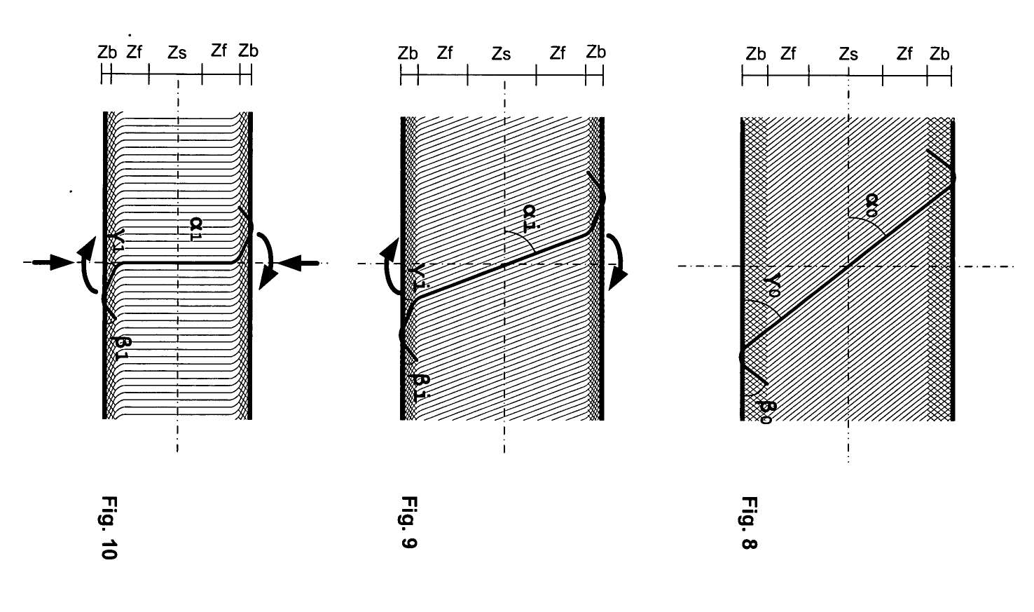

Hereafter, elements having identical functions will be designated by the same references, as shown in FIGS. 1 to 11.

FIG. 1 shows a diagrammatic view in section of a shaping drum T according to the invention in which a shaft 1 of axis XX′ bears two side plates 4 and 4′, at least one of which can slide axially on said shaft 1. The shaft 1 is connected to a chassis, not shown, by means of a motor-driven rotating link.

Sliders 3 and 3′ are driven by a worm 2, which is driven in rotation by a motor 5, so as to effect the axial displacement of the side plates. Motor-driven drive systems, 7, 7′, arranged on the sliders 3 and 3′, drive the side plates 4 and 4′ in rotation and in opposite directions, about the axis XX′.

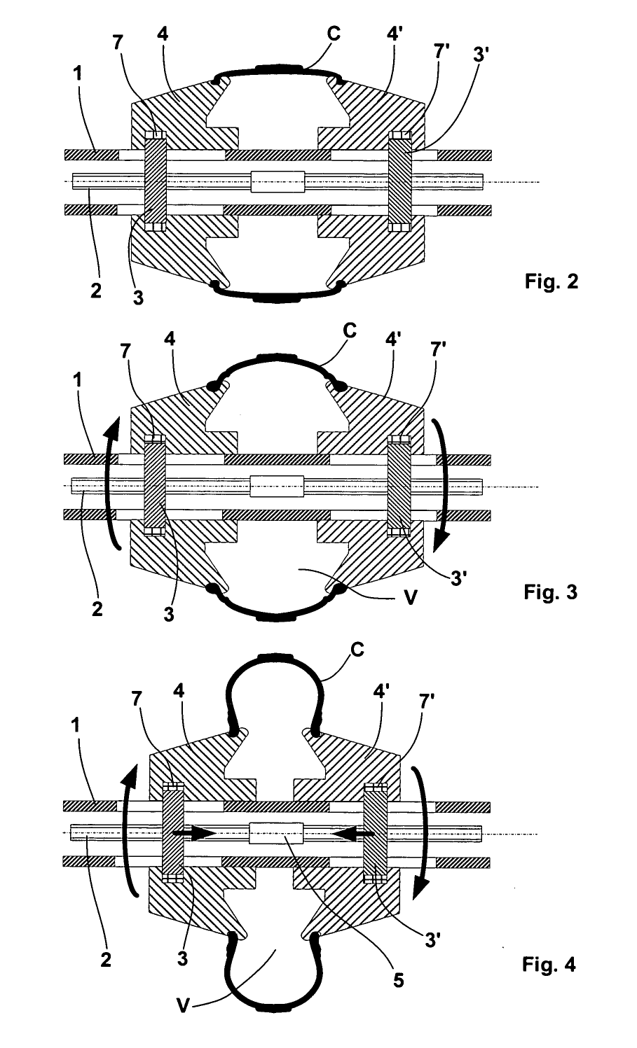

On each of the side plates 4 and 4′ are arranged circumferential receiving grooves 6 and 6′ intended to receive the heels of a carcass C to be shaped, as is illustrated in FIGS. 2, 3 and 4. Preferably, what is called a “membrane-less” shaping process will be used, so as not to hinder the movements in the circumferential direction of the different parts of the carcass being shaped.

Thus the receiving grooves are designed to hold the heels during the shaping of the carcass but also to form an airtight connection making it possible to increase the pressure within the volume V defined by the side plates and by the tire carcass. The connection between the side plates 4 and 4′ and the shaft 1 will, for the same reasons, have to be airtight in order to permit the shaping of the carcass and the rotation of at least one of them simultaneously.

FIGS. 2, 3 and 4 illustrate the main stages of the phase of shaping a carcass C constituting the blank of a tire.

The carcass is arranged on the drum T such that the heels are held by the two receiving grooves 6 and 6′, as shown in FIG. 2.

The increase in the pressure within the volume V defined by the side plates and by the tire carcass causes rounding of the carcass and natural rotation of the side plates about the axis XX′ due simply to the radialization of the cords of the carcass reinforcement ply located in the sidewall zone, as is illustrated in FIG. 3.

FIG. 4 represents the last phase of the shaping during which the motor 5 controls the axial approach of the side plates 4 and 4′ one towards the other.

During this final phase of the shaping, the motor-driven drive systems 7 and 7′ cause the side plates 4 and 4′ to rotate about the axis XX′ by a predetermined angle. To this end, the motor-driven drive systems 7 and 7′ may usefully comprise an indexer making it possible to control this rotational movement accurately.

The embodiment of the shaping drum according to the invention may be subject to numerous variants equivalent to the one described above. Thus, when a membrane-less shaping drum is being used, an equivalent form of embodiment drives only one of the two side plates in rotation.

The means for causing the side plates to rotate relative to the axis XX′ may include mechanical elements internal to the drum such as motor-driven drive systems 7 and 7′, but also of means external to said drum, such as mechanical means connected to the chassis of the drum and acting on one of the two side plates in combination with rotation of the shaft 1.

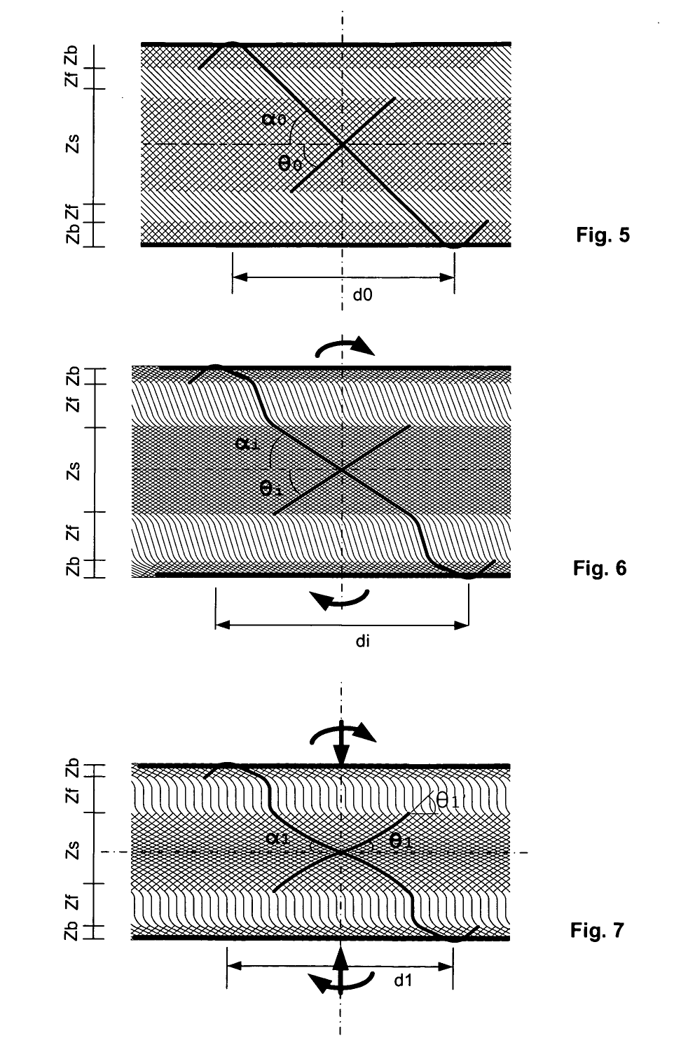

FIGS. 5, 6 and 7 illustrate the phenomenon of triangulation which is utilized in implementing the process.

The carcass reinforcement ply laid on the building drum forms an angle α₀ with the longitudinal or circumferential direction and the crown reinforcement ply forms an angle θ₀ with this same direction. The angles α₀ and θ₀ are of opposite sign. The anchoring points of a cord of the carcass reinforcement ply around the bead wire are located at a circumferential distance d₀.

During the pressurization of the volume V as illustrated in FIG. 3, the values of the angles α and θ of the reinforcement cords of that part of the carcass reinforcement ply located in the crown zone Zs and of the crown reinforcement ply change to values αᵢ and θᵢ, the absolute values of which are less than the absolute values of the angles α₀ and θ₀ respectively. The absolute value of the angular orientation of that part of the carcass ply located in the zone of the sidewalls Zf increases towards the radial direction. The heels begin to turn in the opposite direction from each other and the anchoring points of a cord of the carcass reinforcement ply pass at a circumferential distance d₁ which is different from d₀.

By bringing the side plates toward one another to finish the shaping, the heels continue to turn in opposite directions, and the cords of the carcass ply which are located in the sidewall zone Zf then reach a position close to the radial direction. The angles α and θ of the reinforcement cords of that part of the carcass reinforcement ply located in the crown zone Zs and of the crown reinforcement ply change to values αᵢ and θᵢ, the absolute values of which are less than the absolute values of the angles αᵢ and θᵢ respectively; the anchoring points of one and the same cord of the carcass reinforcement ply are located at a circumferential distance d₁ which is different from dᵢ and d₀. The relative rotation by a predetermined value about the axis XX′ of the side plates 4 and 4′ relative to one another makes it possible to obtain a constant circumferential distance d₁ and to adjust accurately the circumference at the crown of the carcass at the end of shaping and also the value of the angles α₁ and θ₁.

It will be noted that this control of the side plates in rotation proves particularly useful at the end of shaping so as to adjust the respective positions of the plies, but that it is possible to allow the side plates to turn practically freely as a function of the circumferential stresses transmitted to the heels during the first phase of said shaping operation.

The determination of the angle of rotation of the side plates relative to one another and of the value of the angles α₀ and θ₀ so as to obtain the final values α₁ and θ₁ requires the knowledge of the person skilled in the art, who will find the necessary references in the publication FR 2 797 213 already mentioned.

FIGS. 5 to 10 illustrate the possibility of using the same drum to effect triangulation of the reinforcement cords of the carcass ply in the zone of the heel Zb. This is possible when a tire carcass has been produced, the cords of which form an angle α₀ of less than 90° with the circumferential direction.

At the moment of turning up the carcass reinforcement ply around the bead wire, it is possible to make the ply adhere to itself. The reinforcement cords then form an angle β₀ with the circumferential direction; the angle β₀ is of a value substantially equal to and of the opposite sign to the angle γ₀ formed by the carcass reinforcement cords in the zone of the heel Zb, the angle γ₀ being equal, before the shaping commences, to the angle α₀ formed with the circumferential direction by the reinforcement cords of the carcass ply between the two bead wires.

On shaping the carcass, the angles βᵢ and γᵢ narrow to reach, at the end of shaping, the values β₁ and γ₁ respectively. In the absence of a crown reinforcement ply, the cords of the carcass reinforcement ply which are located in the sidewall zones Zf and in the crown zone Zs are radialized relative to the circumferential direction.

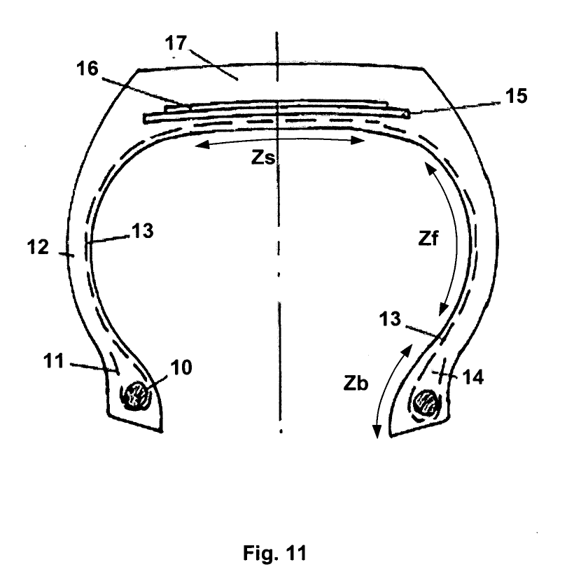

The process for producing a tire as shown in the diagrammatic sectional view of FIG. 11 includes:

laying on a cylindrical building drum at least one carcass reinforcement ply 13 formed of reinforcement cords forming an angle α₀ with the circumferential direction,

laying the annular elements of the heel, comprising the bead wires 10, the profiled elements and heel filling rubbers 14,

turning up the ply edges around the bead wires 10 to form the carcass upturn 11,

laying the crown reinforcement ply 15 composed of reinforcement cords forming an angle θ₀ with the circumferential direction, said angle θ₀ being of the opposite sign to α₀, and, if necessary, making the crown reinforcement ply 15 adhere to the carcass reinforcement ply 13,

laying the rubber profiled elements forming the protection of the sidewall 12,

extracting the carcass of cylindrical form thus produced from the building drum and placing it on a shaping drum T as described previously,

shaping the carcass by pivoting at least one of the side plates 4, 4′ of the shaping drum holding the heels by a predetermined angle about the axis XX′, while bringing said side plates 4, 4′ axially towards one another, until the carcass reinforcement cords located in the sidewall zone are arranged substantially radially,

ending the production of the tire blank by laying the rubber profiled elements intended to form the crown zone and comprising a tread 17 and possibly a second crown reinforcement ply 16,

vulcanising the tire blank in a mold.

It should be noted, as shown in FIGS. 5 to 7, that the effect of the triangulation of the plies in the crown zone is that, on emerging from the shaping stage, the reinforcement cords are arranged at angles α₁ and θ₁ relative to the circumferential direction. However, owing on one hand to the rubbery nature of the connection produced between the carcass reinforcement ply and the crown reinforcement ply, but on the other hand to the form of the transverse profile close to the tire equilibrium curve of the carcass at the end of shaping, the result of which profile is to have a greater circumferential development at the centre of the crown zone than at the margins of the plies, bringing about an amount of elongation and hence of triangulation which is different at the crown than at the edges of the ply, the angles α₁ and θ₁ have a tendency to open gradually at the ply edge to reach angles α₁′ and θ₁′ greater in absolute value than α₁ and θ₁ respectively.

This type of crown, referred to as a crown having a variable angle at the ply edge, is known and described by way of example in the publications FR 2 037 520, or alternatively FR 1 584 691 has the advantage of increased comfort and greater resistance to bearing heavy loads.

The production process disclosed in publication FR 2 037 520 proposes the use of anti-adhesion systems located at the interface of the ply margins, which provides the latter with a degree of freedom during the triangulation, the result of which is the formation of an angle which is more open at the ply edge than on the central part of the ply. The processes described in publication FR 1 584 691 or alternatively in publication FR 1 561 130 propose bending the “cord elements” in the marginal or edge regions; this operation being carried out during the production of the carcass.

The process according to the invention claimed in the present document makes it possible to obtain a similar effect without it being necessary to use such devices.

Finally, this process of using a drum according to the invention may adapt to a large number of variant embodiments.

A first variant consists of laying a carcass reinforcement ply forming an angle α₀ close to the radial direction. The effect of the triangulation, during the shaping, will then make itself felt only in the crown zone Zs.

A second variant consists of laying the first crown reinforcement ply 15 at an intermediate stage of the shaping, with the aim of obtaining triangulations of different angles in the bottom zone and in the crown.

Another alternative consists of producing tires in which the upturns 11 of the carcass reinforcement ply 13 form a given angle β₁ with the circumferential direction. The portion of ply located in the heel zone Zb itself forms an angle γ₁ with the circumferential direction. However, it is also possible to produce the upturn of the carcass ply 11 only once the shaping has been performed. Under these conditions, the carcass reinforcement ply is substantially radial in the zone of the heel Zb; on the other hand, the upturn forms an angle β with the circumferential direction. By producing the upturn of the carcass ply at an intermediate stage in the shaping it is also possible to combine the effects described above.

Finally, this process can be adapted without difficulties to the different tire building drum technologies, in particular when the phases of production of the cylindrical carcass, of shaping and of finishing of the tire blank take place on a single drum.

We I claim:

1. A shaping drum (T) for a tire carcass (C), comprising two side plates (4, 4′), mounted on a shaft (1) of axis XX′ and moving axially on said shaft, said side plates comprising circumferential receiving grooves (6, 6′) intended to hold the heels of the tire to be shaped, while forming an airtight contact with said heels, and in which the shaping of the tire takes place by increasing the air pressure within the volume (V) defined by the side plates and by the inner surface of the tire (C), and by bringing together the side plates (4, 4′), wherein at least one of the side plates (4, ′4) can be driven in rotation about said axis XX′ relative to the other side plate.

2. The shaping drum according to claim 1, in which the rotation of the side plates (4, 4′) about the axis XX′ is driven by the rotation of the heels about said axis XX′.

3. The shaping drum according to claim 1, in which the rotation of the side plates (4, 4′) about the axis XX′ is driven by motor-driven elements (7, 7′).

4. The shaping drum according to claim 1, in which a single side plate (4, 4′) performs a rotation relative to the other side plate about the axis XX′.

5. A process for the production of a tire comprising a carcass reinforcement (13) formed of reinforcement cords coated in a rubber mix and arranged substantially radially in the zone (Zf) of the sidewalls, said reinforcement cords having, on one part of the zone (Zs) over which a crown reinforcement extends, an orientation cc relative to the circumferential direction which deviates substantially from the radial orientation, said crown reinforcement being composed of at least one layer of elements of reinforcement cords coated in a rubber mix (15) and forming an angle θ₁ relative to the circumferential direction and of the opposite sign to α₁, which process comprises the steps of:
laying on a cylindrical building drum at least one carcass reinforcement ply (13) formed of reinforcement cords forming an angle α₀ with the circumferential direction, the absolute value of α₀ being greater than that of α₁;
laying the annular elements of the heel, comprising the bead wires (10), the profiled elements and heel filling rubbers (14);
turning up the ends of the carcass reinforcement ply around the bead wire (10) to form the carcass upturn (11), and making the upturn (11) adhere to the carcass ply (13);
laying a first crown reinforcement ply (15) composed of reinforcement cords forming an angle θ₀ with the circumferential direction and of opposite sign to α₀, the absolute value of said angle θ₀ being greater than the absolute value of the angle θ₁, and making the crown reinforcement ply (15) adhere to the carcass reinforcement ply (13);
laying the rubber profiled elements forming the protection of the sidewall 12;
extracting the carcass of cylindrical form thus produced from the building drum and placing it on a shaping drum (T) comprising side plates (4, 4′), mounted on a shaft (1) of axis XX′ and moving axially on said shaft (1), said side plates (4, 4′) comprising circumferential receiving grooves (6, 6′) intended to hold the heels of the tire to be shaped while forming an airtight contact with said heels, and in which the shaping of the tire takes place by increasing the air pressure within the volume (V) defined by the side plates and by the tire carcass (C) and by bringing together the side plates (4, 4′), and at least one of the side plates of which is driven in rotation about the axis XX′ relative to the other side plate;
shaping the carcass by the side plates holding the heels (4, 4′) pivoting relative to one another by a predetermined angle about the axis XX′ of the shaping drum, while bringing said side plates (4, 4′) axially towards one another, until the carcass reinforcement cords located in the sidewall zone are arranged substantially radially;
ending the production of the tire blank by laying the rubber mixes intended to form the crown zone and comprising a tread (17) and possibly a second crown reinforcement ply (16); and
vulcanising the tire blank in a mold.

6. The process for the production of a tire according to claim 5, in which the angle α₀ is substantially equal to 900.

7. The process for the production of a tire according to claim 5, in which the reinforcement cords of the first crown reinforcement ply (15) form, at the ply edge, an angle θ₁′ with the circumferential direction greater in absolute value than the angle θ₁.

8. The process for the production of a tire according to claim 5, in which the second crown reinforcement ply (16) is what is called a zero-degree ply.

9. The process for the production of a tire according to claim 5, in which the step of turning up the carcass ply (11) around the bead wire (10) and the step of laying the rubber profiled elements forming the protection of the sidewall (12) take place during the step of shaping the carcass.

10. The process for the production of a tire according to claim 5, in which the first crown reinforcement ply (15) is laid in an intermediate step of the shaping operation.
